(19) United States
(12) Patent Application Publication
(10) Pub. No.: US 2006/0206331 A1
(43) Pub. Date: Sep. 14, 2006

(54) Multilingual speech recognition

(76) Inventors: Marcus Hennecke, Ulm (DE); Thomas Krippgans, Ulm (DE)

Correspondence Address: THE ECLIPSE GROUP, 10605 BALBOA BLVD., SUITE 300, GRANADA HILLS, CA, 91344, US

(21) Appl. No.: 11/360,024

(22) Filed: Feb. 21, 2006

(30) Foreign Application Priority Data
Feb. 21, 2005 (EP) 05 003 670.6

(51) Int. Cl. G10L 15/04

(52) U.S. Cl. 704/254

(57) ABSTRACT

A speech recognition system is provided for selecting, via a speech input, an item from a list of items, includes at least using at least two different languages for recognizing at least two strings of subword units for the speech input. The speech recognition system including a subword comparing module for comparing the recognized strings of subword units with subword unit transcriptions of the list items and for generating a candidate list of the best matching items based on the comparison results; and a second speech recognition module for recognizing and selecting an item from the candidate list that best matches the speech input.

### CROSS-REFERENCE TO RELATED APPLICATIONS

This application claims priority of European Patent Application No. 05 003 670.6, filed on Feb. 21, 2005, titled MULTILINGUAL SPEECH RECOGNITION, which is incorporated by reference in this application in its entirety.

### BACKGROUND OF THE INVENTION

1. Field of the Invention

The present invention relates to a speech recognition method and a speech recognition system for selecting, via speech input, an item from a list of items.

2. Related Art

In many applications, such as navigation, name dialing or audio/video player control, it may be necessary to select an item or an entry from a large list of items or entries, such as proper names, addresses, or music titles. With large lists of entries, frequently the list will include entries from more than one language. Use of entries from more than one language poses special challenges for speech recognition system in that neither the language of the intended entry (such as a French name) nor the language spoken by the user to pronounce the intended entry is known to the speech recognition system at the start of the speech recognition task. The French name could be pronounced by the user in French, but if the user does not recognize the name as French or does not speak French, the name may be pronounced in some other language such as the primary language of the user (a language other than French). This complicates the speech recognition process, in particular when the user pronounces a foreign language name for an entry in the user's own native language (sometimes called primary language, first language, or mother tongue). Let's assume for illustration that in a navigation application, a German user wants to select a destination by a street having an English name. It is useful for the speech recognition system to recognize this English street name even though the speech recognition system is configured for a German user and the user mispronounces the street name using German rather than an English pronunciation.

Part of speech recognition involves recognizing the various components of a spoken word, subword units. A fundamental unit in speech recognition is the phoneme. A phoneme is a member of the set of the smallest units of speech that serve to distinguish one utterance from another in a particular language or dialect. In English, the /p/ in pat and the /f/ in fat are two different phonemes.

In order to enable speech recognition with moderate memory and processor resources, a two step speech recognition approach is frequently applied. In the first step, a sequence (string) of discrete phonemes is recognized in the speech input by a phoneme recognizer. However, the recognition accuracy of phoneme recognition is usually not flawless and many substitutions, insertions, and deletions of phonemes occur. Thus, the sequence of phonemes “recognized” by the phoneme recognizer may not be an accurate capture of what the user actually said and the user may not have pronounced the word correctly so that the phoneme string created by the phoneme recognizer may not perfectly match the phoneme string for the target word or phrase to be recognized. The phoneme string is compared with a possibly large list of phonetically transcribed items to determine a shorter candidate list of best matching items. The candidate list is then supplied to the speech recognizer as a new vocabulary for a second recognition pass. In this second step, the most likely entry in the list for the same speech input is determined by matching phonetic acoustic representations of the entries present in the candidate list to the acoustic input in the speech input and determining the best matching entry. This two step approach saves computational resources since the phoneme recognition performed in the first step is less demanding than the recognition process performed in the second step and the computationally expensive second step is performed only with a small subset of the large list of entries.

A two step speech recognition approach is known from DE 102 07 895 A1. The phoneme recognizer utilized in the first step is, however, usually trained for the recognition of phonemes of a single language. Using a phoneme recognizer trained for one specific language on words spoken by a speaker using a different language produces sub-optimal results as the phoneme recognizer works best recognizing components in words from the one specific language and consequently does less well on words pronounced by a speaker using phonemes from other languages than would a phoneme recognizer trained for that specific language.

According, a need exists for a multilingual speech recognition that optimizes the results, particularly when utilizing a two step speech recognition approach for selecting an item from a list of items.

### SUMMARY

A two step speech recognition system is provided for selecting an item from a list of items via speech input. The system includes at least two speech recognition subword modules trained for at least two different languages. Each speech recognition subword module is adapted for recognizing a string of subword units within the speech input. The two step speech recognition system includes a subword comparing unit for comparing the recognized string of subword units with subword unit transcriptions of the list items and for generating a candidate list of the best matching items based on the comparison results, and a second speech recognition unit for recognizing and selecting an item from the candidate list that best matches the speech input at large.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The invention can be better understood with reference to the following figures. The components in the figures are not necessarily to scale, emphasis instead being placed upon illustrating the principles of the invention. Moreover, in the figures, like reference numerals designate corresponding parts throughout the different views.

FIG. 1 is one example of a schematic of a speech recognition system according to one implementation of the invention.

FIG. 2 is an example of a flow chart illustrating the operation of one implementation of the invention.

FIG. 3 is an example of a flow chart for illustrating the details of the subword comparison unit according to one implementation of the invention.

FIG. 4 is an example of a flow chart for illustrating the step of comparing subword unit strings with subword unit transcriptions and the generation of a candidate list in according to one implementation of the invention.

### DETAILED DESCRIPTION

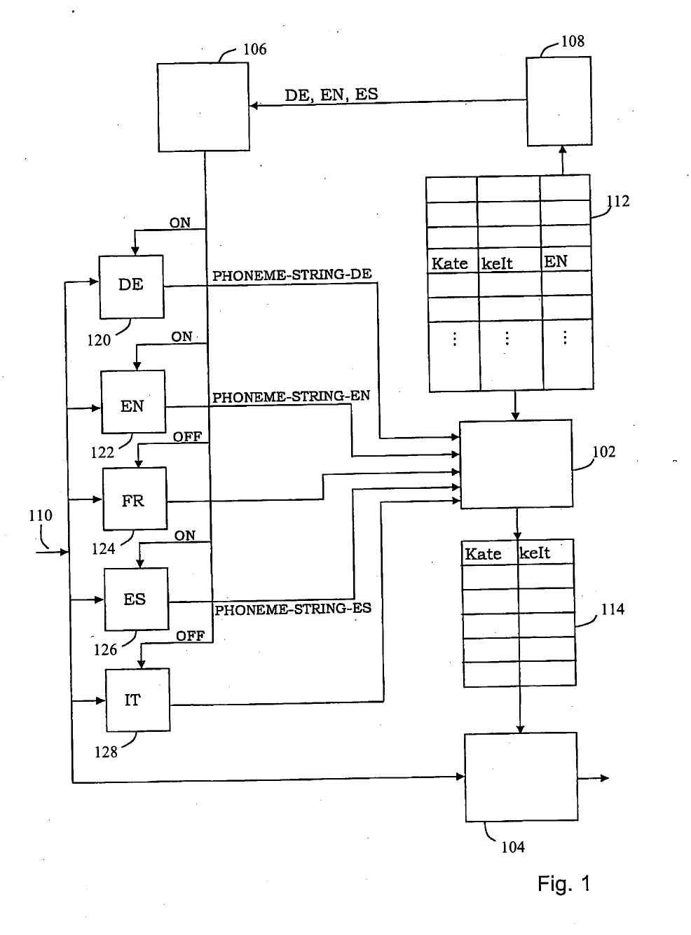

FIG. 1 shows schematically one implementation of a speech recognition system. Speech input 110 from a user for selecting an item from a list of items 112 is input to a plurality of speech recognition me subword units 100 and configured to recognize subword unit strings for different languages. For purposes of illustration, FIG. 1 shows an implementation with five different speech recognition subword modules 100. An actual implementation may have fewer speech recognition subword modules 100 or more than five. The speech recognition subword module 120 may be supplied with characteristic information on German subword units, e.g., hidden Markov models (HMM) trained for German subword units on German speech data. The speech recognition subword module 120, 122, 124, 126 and 128 may be respectively configured to recognize English, French, Spanish, Italian subword units for the speech input 6. Unless otherwise constrained by the operation of a specific implementation, the speech recognition subword module 120, 122, 124, 126 and 128 may operate in parallel using separate recognition modules (e.g., dedicated hardware portions provided on a single chip or multiple chips). Alternatively, the speech recognition subword modules 120, 122, 124, 126 and 128 for the different languages may also operate sequentially on the same speech input 110, e.g., using the same speech recognition engine that is configured to operate in different languages by loading subword unit models for the respective languages. Each recognizer 120, 122, 124, 126 and 128 when activated generates a respective subword unit string composed of the best matching sequence of subword units for the same speech input 110. Then, in the depicted implementation, subword unit strings for German (DE), English (EN), French (FR), Spanish (ES), and Italian (IT) are supplied to a subword comparing unit 102.

Each speech recognition subword module 100 performs a first pass of speech recognition to determine a string of subword, i.e., subword units, for a particular language that best matches the speech input. The speech recognition subword module 100 may be implemented to recognize any sequence of subwords without any restriction. Thus, the subword unit speech recognition is independent of the items in the list of items 112 and the phonetic transcriptions of the items into subword units requires only little computational effort. The sequence of “recognized” subword units output by the speech recognition subword module 100 may be a sequence that is not identical to any one string of subword units transcribed from any of the possible expected entries from the list of entries.

While a subword unit could be a phoneme, it does not have to be. Implementations may be created where a subword unit corresponds to: a phoneme, a syllable of a language, or any other units such as larger groups of phonemes, or smaller groups such as demiphone. The list of possible expected entries may be broken down into transcriptions of the same type of subword units as used by the speech recognition subword module 100 to the output of the speech recognition subword module 100 can be compared against the various entry transcriptions.

While one implementation of the method utilized in the speech recognition system uses at least using at least two languages, nothing in this method excludes using additional speech recognition subword modules 100 such that are configured to work in the same language. Such an implementation may be utilized if two different speech recognition subword modules 100 vary considerably in their operation such that the aggregate result of using both for a single language may be better than the results of using either one of the speech recognition subword module 100.

To reduce the computational load incurred with the subword unit recognition for different languages, language identification module 108 for identifying the language or languages of the items contained in the list of items 112 may be provided. The language identification module 108 scans the list of items 112 to determine the language or languages of individual items by analyzing the subword unit transcription or the orthographic transcription corresponding to an item for finding specific phonetic properties characteristic for a particular language or by applying a language identifier stored in association with the item.

The list of items 112 in the depicted implementation includes for each item: the name of the item; at least one phonetic transcription of the item; and a language identifier for the item. An example for a name item in a name dialing application is given below:

| | | |
|---|---|---|
| Kate Ryan | \|keIt\|raI\|@n\| | enUS |

where the phonetic notation in this example uses the SAMPA phonetic alphabet and indicates also the syllable boundaries. SAMPA is an acronym for Speech Assessment Methods Phonetic Alphabet. Alternatively, other phonetic notations, alphabets (such as IPA (International Phonetic Alphabet)), and language identifiers may be applied.

If multiple transcriptions in different languages for an item are provided in the list of items 112, the individual transcriptions may be tagged with corresponding language identifiers to mark the language of the transcription. In a particular implementation, whenever a particular item has different associated languages, each will be considered by the language identification module 108. The language identification module 108 may collect a list of all the different languages for the items or transcriptions in the list of items 112 and provides a list of identified languages to a speech recognition controller 106. The speech recognition controller 106 may be a device that is capable of controlling the operations of a speech recognition system. The speech recognition controller 106 may be, or may include, a processor, microprocessor, application specific integrated circuit (“ASIC”), digital signal processor (“DSP”), or any other similar type of programmable device that is capable of either control the speech recognition system or processing data from the speech recognition system, or both. The programming of the device may be either hardwired or software based.

An example for a list item in an application to select audio files is given below. Here, the audio file may be selected by referring to its title or performer (performing artist). The phonetic transcriptions or subword units corresponding to the different identifiers of the file may, of course, belong to different languages.

| | | Language of | | Language of |
|---|---|---|---|---|
| File | Title | Title | Artist | Artist |
| Xyz | \|1A\|pRo\|mEs\| | frBE | \|keIt\|raI\|@n\| | enUS |
| | (La Promesse) | | (Kate Ryan) | |

The speech recognition controller 106 controls the operation of the speech recognition subword module 100 and activate the specific speech recognition subword module 100 suitable for the current application based on the language(s) identified by the language identification module 108. Since it is very likely that the user will pronounce the name of a list item in one of the one or more corresponding language(s) for that particular list item, the specific speech recognition subword module 120, 122, 124, 126 and 128 corresponding to the output of the language identification module 108 may be activated. It may be useful to add the native language of the user to the output from the language identification module 108 if the native language is not already listed, since a user is also likely to pronounce a foreign name in the user's native language. The addition of the user's native language has a particular advantage in a navigation application when the user travels abroad. In this case, a situation may arise where a user pronounces a foreign street name in the navigation application using pronunciation rules of the user's native language. In the example depicted in FIG. 1, the language identification module 108 identifies German, English and Spanish names for entries in the list of items 112 and supplies the respective information to the speech recognition controller 104 that, in turn, activates the German speech recognition subword module 120, the English speech recognition subword module 122 and the Spanish speech recognition subword module 126. The French speech recognition subword module 124 and the Italian speech recognition subword module 128 are not activated or deactivated since no French or Italian names appear in the list of items 112 (and the user's native language is not understood to be French or Italian).

Thus, only a selected subset of the plurality of speech recognition subword modules 100 use resources to perform subword unit recognition and the generation of subword unit strings. Speech recognition subword modules 100 that are not expected to provide a reasonable result do not take up resources. Appropriately selecting the speech recognition subword module 100 for a particular application or a context reduces the computational load from the subword unit recognition activity. The activation of the at least two selected speech recognition subword modules 120, 122, 124, 126 and 128 may be based in part on a preferred language of a user (or at least an assumption of the preferred language of the user). The preferred language may be: pre-selected for the speech recognition system, e.g., set to the language of the region where the apparatus is usually in use (i.e., stored in configuration information of the apparatus); selected by the user using language selection means such as an input device for changing the apparatus configuration; or selected based on some other criteria. In many implementations, the preferred language may be set to the native language of the user of the speech recognition system since this is the most likely language of usage by that user.

The dynamic selection of speech recognition subword module 100 may be independent for different applications in utilizing the speech recognition system. For instance, in an automobile, a German and an English speech recognition subword module 120 and 122 may be activated for a name dialing application while a German and a French speech recognition subword module 120 and 124 may operate in an address selection application for navigation performed with the same speech recognition system.

The language identification of a list item in the list of items 112 may be based on a language identifier stored in association with the list item. In this case, the language identification module 108 determines the set of all language identifiers for the list of items relevant to an application and selects the corresponding subword unit speech recognizers. Alternatively, the language identification of a list item may be determined based on a phonetic property of the subword unit transcription of the list item. Since typical phonetic properties of subword unit transcriptions of different languages usually vary among the languages and have characteristic features that may be detected, e.g., by rule sets applied to the subword unit transcriptions, the language identification of the list items may be performed without the need of stored language identifiers.

The subword comparing module 102 compares the recognized strings of subword units output from the speech recognition subword module 100 with the subword unit transcriptions of the list of items 112 as will be explained in more detail below. Based on the comparison results, a candidate list 114 of the best matching items from the list of items 112 is generated and supplied as vocabulary to a second speech recognition module 104. The candidate list 114 includes the names and subword unit transcriptions of the selected items. In at least one implementation, the language identifiers for the individual items need not be included.

The second speech recognition module 104 is configured to recognize, from the same speech input 110, the best matching item among the items listed in the candidate list 114, a subset of the list of items 110. The second speech recognition module 104 compares the speech input 110 with acoustic representations of the items in the candidate list 114 and calculates a measure of similarity between the acoustic representations of items in the candidate list 114 and the speech input 110. The second speech recognition module 104 may be an integrated word (item name) recognizer that uses concatenated subword models for acoustic representation of the list items. The subword unit transcriptions of the candidate list 114 items serve to define the concatenations of subword units for the speech recognition vocabulary. The second speech recognition module 104 may be implemented by using the same speech recognition engine as the speech recognition subword module 100, but configured to allow only the recognition of candidate list 114 items. The speech recognizer subword module 100 and the second speech recognizer module 104 may be implemented using the same speech recognition algorithm, HMM models and software operating on a microprocessor or analogous hardware. The acoustic representation of an item from the candidate list 114 may be generated, e.g., by concatenating the phoneme HMM models defined by the subword unit transcription of the items.

While the speech recognition subword module 100 may be configured to operate relatively unconstrained such that it is free to recognize and output any sequence of subword units, the second recognizer 104 may be constrained to recognize only sequences of subword units that correspond to subword unit transcriptions corresponding to the recognition vocabulary given by the candidate list items. Since the second speech recognizer 104 operates only on a subset of the items (i.e. the candidate list), this reduces the amount of computation required as there are only a relatively few possible matches. As one aspect of the demand for computation has been drastically reduced, there may be an opportunity for utilizing acoustic representations that may be more complex and elaborate to achieve a higher accuracy. Thus for example, tri-phone HMMs may be utilized for the second speech recognition pass.

The best matching item from the candidate list 114 is selected and corresponding information indicating the selected item is output from the second speech recognition module 104. The second speech recognition module 104 may be configured to enable the recognition of the item names, such as names of persons, streets, addresses, music titles, or music artists. The output from the second speech recognition module 104 may be input as a selection to an application (not shown) such as name dialing, navigation, or control of audio equipment. Multilingual speech recognition may be applied to select items in different languages from a list of items such as the selection of audio or video files by title or performer (performing artist).

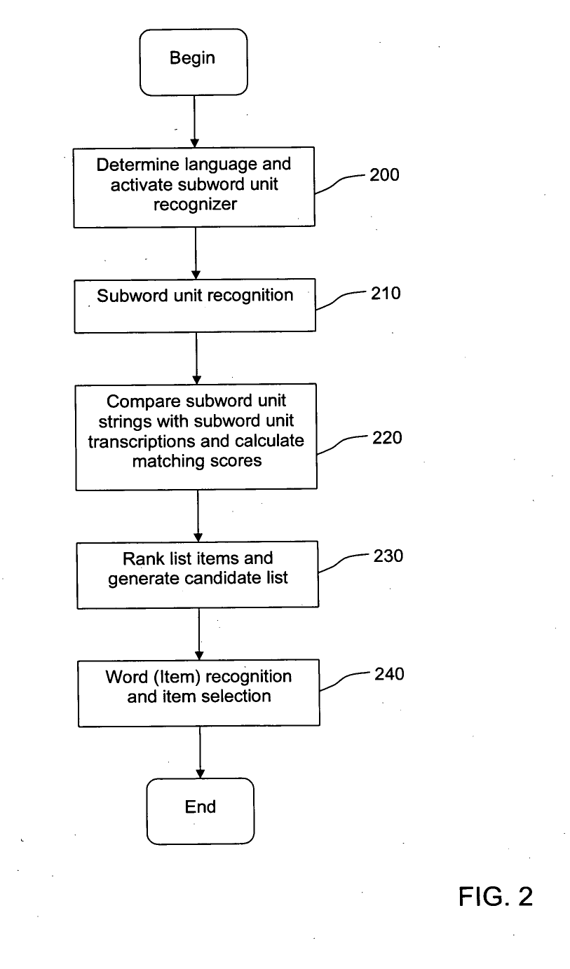

FIG. 2 is a flow chart for illustrating the operation of an implementation of the speech recognition system and the speech recognition method. In step 200, the necessary languages for an application are determined and their respective speech recognition subword module 100 (See FIG. 1) are activated. The languages may be determined based on language information supplied from the list of items 112 (See FIG. 1). As mentioned above, the native language of the user may be added if not already included after review of the material from the list of items 112 (See FIG. 1).

After the necessary speech recognition subword modules 120, 122, 124, 126 and 128 are activated (See FIG. 1), the subword unit recognition for the identified languages is performed in step 210, and subword unit strings for all active languages are generated by the subword unit recognizers.

The recognized subword unit strings are then compared with the subword unit transcriptions of the items in the list of items in step 220, and a matching score for each list item is calculated. The calculation of the matching score is based on the dynamic programming algorithm to allow for substitutions, insertions, and deletions of subword units in the subword unit string. This approach considers the potentially inaccurate characteristics of subword unit recognition that may misrecognize short subword units.

If the language of an item or its subword unit transcription is known, an implementation may be configured to restrict the comparison to the recognized subword unit string of the same language since it is very likely that this pairing has the highest correspondence. Thus, in this particular implementation, if the list of items has words in Spanish, German, and English, the subword unit string from the transcription of a Spanish word would be compared to the output string from the speech recognition subword module 126 for the Spanish language but not necessarily to the output from the speech recognition subword module for the English language 122 (unless the native language of the user is known to be English as discussed below).

Since it is also possible that the user has pronounced a foreign item in the user's native language, the subword unit transcription of the item may be further compared to the recognized subword unit string of the user's native language. Thus, for a user thought to have English as the user's native language, the subword unit transcription for a Spanish word would be compared against the output from the Spanish speech recognition subword module 126 and the output from the English speech recognition subword module 122. Each comparison generates a score. The best matching score for the item among all calculated scores from comparisons with the subword strings from the speech recognition subword module 100 for different languages is determined and selected as the matching score for the item.

It is also possible that a single selection choice to be represented in the list of list items has a plurality of subword unit transcriptions associated with different languages. Thus, there may be several table entries for a single selection choice, with each choice having a different associated language and subword unit transcription.

An implementation may be configured so that a recognized subword unit string for a certain language may be compared with only subword unit transcriptions of an item corresponding to the same language. Since only compatible subword unit strings and subword unit transcriptions of the same language are compared, the computational effort is reduced and accidental matches may be avoided. The matching score of a list item may be calculated as the best matching score of the various pairs of subword unit transcriptions of the item and subword unit strings in the corresponding language. Thus, in this implementation, a word that it pronounced differently in English and French would have the output from the English speech recognition subword module 122 compared with the subword unit transcription of the word as pronounced in English and the output of the French speech recognition subword module 124 would be compared with the subword unit transcription of the word as pronounced in French.

In another implementation, each entry may also be compared against the preferred language, such as the native language of the user. In the preceding example, all entries would be compared against the preferred language subword unit string for the preferred language even if the listed entry item was associated with another language. Thus, the entry for the item as pronounced in English would be compared against the English subword unit string and against the German subunit word string and the entry for the item as pronounced in French would be compared against the French subunit word string and against the German subunit word string.

The list items are ranked according to their matching scores in step 230 and a candidate list of the best matching items is generated. The candidate list 11 (See FIG. 1) may comprise a given number of items having the best matching scores. Alternatively, the number of items in the candidate list 11 may be determined based on the values of the matching scores, e.g., so that a certain relation between the best matching item in the candidate list 11 and the worst matching item in the candidate list 11 is satisfied (for instance, all items with scores within a predetermined range or ratio to the best score).

In step 240, the “item name” recognition is performed and the best matching item is determined. This item is selected from the candidate list 11 and supplied to an application (not shown) for further processing.

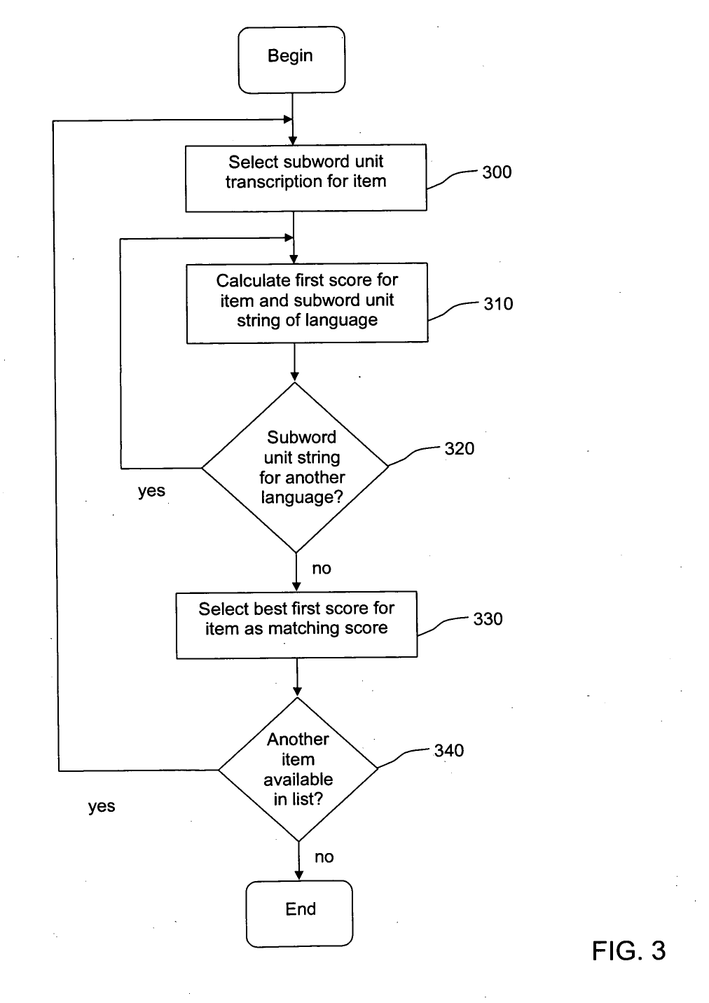

Details of the step 220 for the subword comparison step for an implementation of a speech recognition method are illustrated in FIG. 3. The implementation shown in FIG. 3 may be particularly useful when language identification for the list items or subword unit transcriptions is not available. Within this implementation a set of “first scores” are calculated for matches of a subword unit transcription of a list item with each of the subword unit strings output from the speech recognition subword module for the different languages. Thus, a subword unit transcription of a list item receives a set of first scores indicating each the degree of correspondence with the subword unit strings of the different languages. The best first score calculated for the item may be selected as matching score of the item and utilized in ranking the plurality of items from the list and generating the candidate list. This implementation works without knowing the language of the list item. It is likely that the best first score, the one used as the matching score, will come from a comparison of the subword unit transcription for an entry in a particular language and the output from the speech recognition subword module trained in that particular language.

A first item from the list of items 112 (See FIG. 1) is selected in step 300, and the subword unit transcription of the item is retrieved. In steps 310 and 320, first scores for matches of the subword unit transcription for the item with the subword unit strings of the recognition languages are calculated. For each of the recognition languages, a respective first score is determined by comparing the subword unit transcription with the subword unit string recognized for the language. Step 310 is repeated for all activated recognition languages.

The best first score for the item is selected in step 330 and recorded as matching score of the item. The later ranking of the items will be based on the matching scores, i.e., the respective best first scores of the items.

While one implementation may use the best (highest) first score as the representative matching score for an item, other implementations may utilize some other combination of the various first scores for a particular item. For example, an implementation may use the mean of two or more scores for an item.

The process of calculating matching scores for an item is repeated, if it is determined in step 340 that an additional item is available in the list of items 112. Otherwise, the calculation of matching scores for list of items 112 is finished.

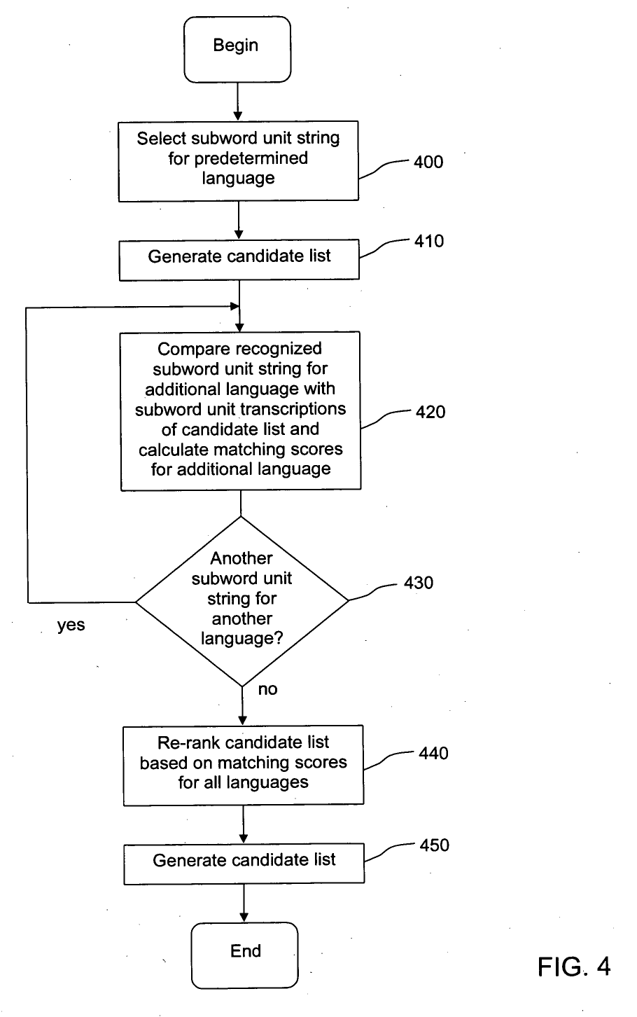

FIG. 4 shows a flow diagram for illustrating the comparison of subword unit strings with subword unit transcriptions and the generation of a candidate list according to another implementation of a speech recognition method.

In step 400, a subword unit string for a preferred language is selected. The preferred language is usually the native language of the user. The preferred language may be input by the user, be preset, e.g., according to a geographic region, be selected based on the recent history of operation of the speech recognition system, or be selected based upon some other criteria.

A larger than usual candidate list 114 is generated based on the comparison results of the selected subword unit string with the subword unit transcriptions of the list of items 112 in step 410. As the creation of this initial candidate list is intended to filter out very weak matches to reduce the number of comparisons examined between subword unit strings from other speech recognition subword modules 100, the selection criteria to be placed on this initial candidate list 114 can be relatively generous as the list will be pruned in a subsequent step.

Next, the recognized subword unit string for an additional language is compared with the subword unit transcriptions of items listed in the candidate list 114 and matching scores for the additional language are calculated. This is repeated for all additional languages that have been activated (step 430).

The candidate list is re-ranked in step 440 based on matching scores for the items in the candidate list for all languages. This means that items that had initially a low matching score for the predetermined “preferred” language (but high enough to survive the initial filtering) may receive a better score for an additional language and, thus, receive a higher rank in the candidate list. Since the comparison of the subword unit strings for the additional languages is not performed with the original (possibly very large) list of items 112, but with the smaller candidate list 114, the computational effort of the comparison step may be reduced. This approach is usually justified since the pronunciations of the list items in different languages do not deviate too much. In this case, the user's native language or some other predetermined “preferred” language may be utilized for a first selection of candidate list 114 items, and the selected items may be rescored based on the subword unit recognition results for the other languages.

For example, the German speech recognition subword module 120 (corresponding to the native language of the user for this example) is applied first and a large candidate list is generated based on the matching scores of the list items with the German subword unit string. Then, the items listed in the candidate list are re-ranked based on matching scores for English and French subword unit strings generated from respective speech recognition subword module 122 and 124 of these languages

The relatively large candidate list is pruned in step 450 and cut back to a size suitable as vocabulary size for the second speech recognizer.

The disclosed method and apparatus allows items to be selected from a list of items while the language that the user applies for pronunciation of the list item is not known. The implementations discussed are based on a two step speech recognition approach that uses a first subword unit recognition step to select candidates for the second, more accurate recognition pass. The implementations discussed above reduce the computation time and memory requirements for multilingual speech recognition.

As noted in the example above, sub-variations within a language may be noted and is so desired, treated as separate languages. Thus, English as spoken in the United States may be treated separately from English as spoken in Britain or English spoken in Jamaica. There is nothing inherent in the disclosed speech recognition method that would preclude loading subword unit speech recognition units for various dialects within a country and treating them as separate languages. For example, there may be considerable differences in the pronunciation of words in the American city of New Orleans as compared to a pronunciation of the same word in the American city of Boston.

In order to enhance the accuracy of the subword unit recognition, it is possible to generate a graph of subword units that match the speech input. A graph of subword units may comprise subword units and possible alternatives that correspond to parts of the speech input. The graph of subword units may be compared to the subword unit transcriptions of the list items and a score for each list item may be calculated, e.g., by using appropriate search techniques such as dynamic programming.

The speech recognition controller 106, language identification module 108, and subword unit comparing module 102, speech recognition subword module 100, and second speech recognition module 104 may be implemented on a range of hardware platforms with appropriate software, firmware, or combinations of firmware and software. The hardware may include general purpose hardware such as a general purpose microprocessor or microcontroller for use in an embedded system. The hardware may include specialized processors such as an application specific integrated circuit (ASIC). The hardware may include memory for holding instructions and for use while processing data. The hardware may include a range of input and output devices and related software so that data, instructions, speech input can be used by the hardware. The hardware may include various communication ports, related hardware, and software to allow the exchange of information with other systems.

One of ordinary skill in the art could take the a process set forth in one of the flow charts used to explain the method and revise the order in which steps are completed. The objective of the patent system to provide an enabling disclosure is not advanced by submitting large numbers of flow charts and corresponding text to describe the possible variations in the order step execution as these variations are inherently provided in the material set forth above. All such variations are intended to be covered by the attached claims unless specifically excluded.

Persons skilled in the art will understand and appreciate, that one or more processes, sub-processes, or process steps described in connection with FIGS. 1 through 4 may be performed by hardware and/or software. Additionally, the speech recognition system may be implemented completely in software that would be executed within a processor or plurality of processor in a networked environment. Examples of a processor include but are not limited to microprocessor, general purpose processor, combination of processors, DSP, any logic or decision processing unit regardless of method of operation, instructions execution/system/apparatus/device and/or ASIC. If the process is performed by software, the software may reside in software memory (not shown) in the device used to execute the software. The software in software memory may include an ordered listing of executable instructions for implementing logical functions (i.e., “logic” that may be implemented either in digital form such as digital circuitry or source code or optical circuitry or chemical or biochemical in analog form such as analog circuitry or an analog source such an analog electrical, sound or video signal), and may selectively be embodied in any signal-bearing (such as a machine-readable and/or computer-readable) medium for use by or in connection with an instruction execution system, apparatus, or device, such as a computer-based system, processor-containing system, or other system that may selectively fetch the instructions from the instruction execution system, apparatus, or device and execute the instructions. In the context of this document, a “machine-readable medium,” “computer-readable medium,” and/or “signal-bearing medium” (herein known as a “signal-bearing medium”) is any means that may contain, store, communicate, propagate, or transport the program for use by or in connection with the instruction execution system, apparatus, or device. The signal-bearing medium may selectively be, for example but not limited to, an electronic, magnetic, optical, electromagnetic, infrared, or semiconductor system, apparatus, device, air, water, or propagation medium. More specific examples, but nonetheless a non-exhaustive list, of computer-readable media would include the following: an electrical connection (electronic) having one or more wires; a portable computer diskette (magnetic); a RAM (electronic); a read-only memory “ROM” (electronic); an erasable programmable read-only memory (EPROM or Flash memory) (electronic); an optical fiber (optical); and a portable compact disc read-only memory “CDROM” “DVD” (optical). Note that the computer-readable medium may even be paper or another suitable medium upon which the program is printed, as the program can be electronically captured, via, for instance, optical scanning of the paper or other medium, then compiled, interpreted or otherwise processed in a suitable manner if necessary, and then stored in a computer memory. Additionally, it is appreciated by those skilled in the art that a signal-bearing medium may include carrier wave signals on propagated signals in telecommunication and/or network distributed systems. These propagated signals may be computer (i.e., machine) data signals embodied in the carrier wave signal. The computer/machine data signals may include data or software that is transported or interacts with the carrier wave signal.

While various implementations of the invention have been described, it will be apparent to those of ordinary skill in the art that many more implementations are possible within the scope of this invention. In some cases, aspects of one implementation may be combined with aspects of another implementation to create yet another implementation. Accordingly, the invention is not to be restricted except in light of the attached claims and their equivalents.

What is claimed is:

1. Speech recognition system for selecting, via a speech input, an item from a list of items, comprising:
at least for recognizing a string of subword units in the speech input, including a first speech recognition subword module configured to recognize subword units of a first language, and a second speech recognition subword module configured to recognize subword units of a second language, different from the first language;
a subword comparing module for comparing the recognized string of subword units from the at least with subword unit transcriptions of the list of items and for generating a candidate list of the best matching items based on the comparison results; and
a second speech recognition module for recognizing and selecting an item from the candidate list for the item in the candidate list that best matches the speech input.

2. The speech recognition system of claim 1, including speech recognition controller to control the operation of the at least two speech recognition subword module, the speech recognition controller being configured to selectively activate the at least two of the speech recognition subword module.

3. The speech recognition system of claim 2, where the activation of the at least is based on a preferred language of a user.

4. The speech recognition system of claim 2, including a language identification module for identifying at least one language of the list items, where the identification of the at least one language of the list items is utilized by the speech recognition controller in the activation of the at least two speech recognition subword modules.

5. The speech recognition system of claim 4, where the language identification of a list item is based on a language identifier stored in association with the list item.

6. The speech recognition system of claim 4, where the language identification of a list item is based on a phonetic property of the subword unit transcription of the list item.

7. The speech recognition system of claim 1, where the subword comparing module is configured to compare a recognized subword unit string output from a speech recognition subword module for a certain language only with subword unit transcriptions corresponding to the same language.

8. The speech recognition system of claim 1, where the subword comparing module s configured to calculate a matching score for each item from the list of items, the matching score indicating an extent of a match of a recognized subword unit string with the subword unit transcription of a list item, the calculation of the matching score accounting for insertions and deletions of subword units, the subword comparing module being further configured to rank the items from the list of items according to their matching scores and to list the items with the best matching scores in the candidate list.

9. The speech recognition system of claim 8, where the subword comparing module is configured to generate the candidate list of the best matching items based on the recognized subword unit strings output from the at least by calculating first scores for matches of a subword unit transcription of an item from the list of items with each of the subword unit strings received from the at least and selecting the best first score of the item as the matching score of the item.

10. The speech recognition system of claim 8, where the subword comparing module is configured to compare the string of subword units recognized from a predetermined speech recognition subword module with subword unit transcriptions of all the items of the list of items and to generate the candidate list of the best matching items based on the matching scores of the items, the subword comparing module being further configured to compare the at least one string of subword units recognized from the remaining speech recognition subword module with subword unit transcriptions of items of the candidate list and to re-rank the candidate list based on the matching scores of the candidate list items for the different languages.

11. The speech recognition system of claim 1, where a plurality of subword unit transcriptions in different languages for an item from the list of items are provided, and the subword comparing module is configured to compare a recognized subword unit string output from a speech recognition subword module for a particular language only with the subword unit transcription of the item corresponding to that particular language.

12. The speech recognition system of claim 1, where a speech recognition subword module is configured to compare the speech input with a plurality of subword units for a language, to calculate a measure of similarity between a subword unit and at least a part of the speech input, and to generate the best matching string of subword units for the speech input in terms of the measure of similarity.

13. The speech recognition system of claim 1, where a speech recognition subword module generates a graph of subword units for the speech input.

14. The speech recognition system of claim 1, where a speech recognition subword module generates a graph of subword units for the speech input, including at least one alternative subword unit for a part of the speech input.

15. The speech recognition system of claim 1, where a subword unit corresponds to a phoneme of a language.

16. The speech recognition system of claim 1, where a subword unit corresponds to a syllable of a language.

17. The speech recognition system of claim 1, where the second speech recognition module is configured to compare the speech input with acoustic representations of the candidate list items, to calculate a measure of similarity between an acoustic representation of a candidate list item and the speech input, and to select the candidate list item having the best matching acoustic representation for the speech input in terms of the measure of similarity.

18. Speech recognition method for selecting, via a speech input, an item from a list of items, comprising the steps:
recognizing at least two strings of subword units for the speech input, including a first string of subword units in a first language and a second string of subword units in a second language, the second language different from the first language;
comparing the at least two recognized strings of subword units with subword unit transcriptions of the list items and generating a candidate list of the best matching items based on the comparison results; and
recognizing and selecting an item from the candidate list that best matches the speech input.

19. The speech recognition method of claim 18, including a selection step for selecting at least one of the subword unit strings for comparison with the subword unit transcriptions of the items from the list of items.

20. The speech recognition method of claim 18, including a selection step for selecting the subword unit string recognized using the native language of a speaker that provided the speech input, utilizing the selected subword unit string for comparison with the subword unit transcriptions of the items from the list of items.

21. The speech recognition method of claim 20, where the comparison of subword unit strings recognized using a language other than the native language of the speaker that provided the speech input is performed only with subword unit transcriptions of items placed in the candidate list that is generated based on the comparison results of the subword unit transcriptions with the selected subword unit string, the candidate list being subsequently ranked according to the comparison results for subword unit strings of both the subword unit string recognized using the native language of the speaker and at least one subword unit string recognized using a language other than the native language of the speaker.

22. The speech recognition method of claim 18 including a language identification step for identifying the at least one language utilized in the list of items, where the step of recognizing at least two strings of subword units for the speech input including a first string of subword units in a first language and a second string of subword units in a second language is based at least in part on the identified at least one language utilized in the list of items.

23. The speech recognition method of claim 18, where the comparison of a recognized subword unit string for the first language is performed only with subword unit transcriptions in the first language and the comparison of recognized subword strings for the second language is performed only with subword unit transcriptions in the second language.

24. The speech recognition method of claim 18, where a matching score is calculated for each item from the list of items, the matching score indicating an extent of a match between a recognized subword unit string and the subword unit transcription of an item in the list of items, the calculation of the matching score accounting for insertions and deletions of subword units in the recognized subword unit string.

25. A speech recognition system for recognizing in speech input from a user a particular item from a list of items, the speech recognition system comprising:
a first speech recognition subword module trained for a first language;
a second speech recognition subword module trained for a second language, different from the first language;
a third speech recognition subword module trained for a third language, different from the first and second languages;
a subword comparing module for creation of a candidate list of items for use by a subsequent speech recognition module with the speech input from the user, the candidate list of items containing a subset from the list of items; and
at least one speech recognition controller operating to control the speech recognition system so that:
subword unit strings recognized by the first speech recognition subword module and subword unit strings recognized by the second speech recognition subword module are provided to the subword comparing module but subword unit strings from the third speech recognition subword module are not provided to the subword comparing module when the subword comparing module is comparing subword unit strings against a list of items relevant to a first application; and
subword unit strings recognized by the first speech recognition subword module and subword unit strings recognized by the third speech recognition subword module are provided to the subword comparing module but subword unit strings from the second speech recognition subword module are not provided to the subword comparing module when the subword comparing module is comparing subword unit strings against a list of items relevant to a second application;
such that the speech recognition system can be shared by the first application to recognize subword unit strings using speech recognition subword module trained for the first and second languages, and by the second application to recognize subword unit strings using speech recognition subword module trained for the first and third languages.
